(19) United States
(12) Patent Application Publication
(10) Pub. No.: US 2017/0287217 A1
(43) Pub. Date: Oct. 5, 2017

(54) PRECEDING TRAFFIC ALERT SYSTEM AND METHOD

(71) Applicants: Kahyun Kim, Portland, OR (US); Paul F. Sorenson, Hillsboro, OR (US); Emily N. Ivers, Hillsboro, OR (US)

(72) Inventors: Kahyun Kim, Portland, OR (US); Paul F. Sorenson, Hillsboro, OR (US); Emily N. Ivers, Hillsboro, OR (US)

(21) Appl. No.: 15/085,803

(22) Filed: Mar. 30, 2016

(51) Int. Cl. G06T 19/00; G06K 9/62; H04N 5/225; B62J 27/00; G02B 27/01; G08G 1/16; B62J 99/00; H04N 5/232; G06K 9/00

(52) U.S. Cl. CPC G06T 19/006; H04N 5/23293; G06K 9/6267; H04N 5/2251; G06K 9/00805; G02B 27/0172; G08G 1/166; B62J 99/00; B62J 27/00; G06T 2207/30261; G02B 2027/0138; G02B 2027/014; G02B 2027/0141; B62J 2099/0026; G06T 11/60

(57) ABSTRACT

Various systems and methods for providing alerts of preceding traffic are described herein. A system for providing alerts of preceding traffic comprising a processor installed on a trailing vehicle operated by a user, the processor to: receive image data from a camera and identify a preceding vehicle in front of the trailing vehicle; receive data from a distance sensor to detect a change in relative velocity between the preceding vehicle and the trailing vehicle that exceeds a threshold; and cause an augmented reality content to be displayed in a head-mounted display worn by the user, the augmented reality content to alert the user of the change in relative velocity.

### TECHNICAL FIELD

Embodiments described herein generally relate to motorist assistance apparatus and in particular, to a system and method to alert a user of preceding traffic hazards.

### BACKGROUND

Augmented reality (AR) viewing may be defined as a live view of a real-world environment whose elements are supplemented (e.g., augmented) by computer-generated sensory input such as sound, video, graphics, or haptic feedback. A head-mounted display (HMD), also sometimes referred to as a helmet-mounted display, is a device worn on the head or as part of a helmet that is able to project images in front of one or both eyes of a user. An HMD may be used for various applications including augmented reality or virtual reality simulations. HMDs are used in a variety of fields such as military, gaming, sporting, engineering, and training.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an HMD, according to an embodiment;

FIG. 2 is another HMD, according to embodiment;

FIG. 3 is another example configuration, according to an embodiment;

FIG. 4 is an example augmented reality user interface, according to an embodiment;

FIG. 5 is a schematic drawing illustrating an AR subsystem in the form of a head-mounted display, according to an embodiment;

FIG. 6 is a flowchart illustrating control and data flow, according to an embodiment;

FIG. 7 is a block diagram illustrating a system for traffic monitoring and providing alerts of preceding traffic, according to an embodiment;

FIG. 8 is a flowchart illustrating a method of monitoring and providing alerts regarding preceding traffic, according to an embodiment; and

FIG. 9 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

When riding a bicycle, often it is difficult to judge relative speed of traffic in the field of view. The problem is made more complex when traveling in a crowded environment, for example, with other riders of various skill levels in an urban setting with other distractions such as cars, pedestrians, and road elements. What is needed is an alert system to provide an intuitive and effective notification to a user of potential hazards in the preceding and surrounding traffic.

Systems and methods described herein implement a head-mounted display (HMD) to present an augmented reality with alerts and other indicia to warn a user of potential hazards. HMDs come in a variety of form factors including goggles, visors, glasses, helmets with face shields, and the like. In an example, a bike helmet may be fitted with a display surface and act as an HMD for a bicyclist. As the bicyclist is biking, an augmented reality overlay is used to provide signals to the bicyclist of other bicyclists that are braking or stopped and that may be a potential collision hazard.

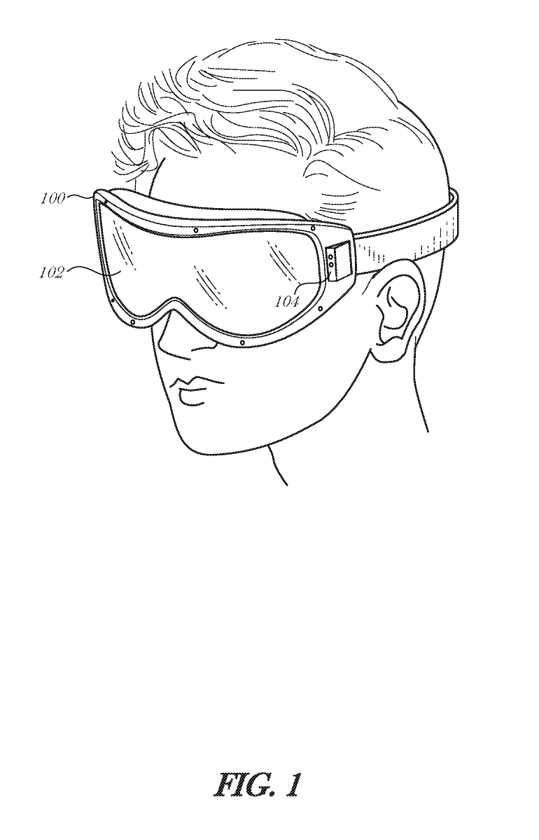

FIG. 1 is an HMD 100, according to an embodiment. The HMD 100 includes a display surface 102, a camera array 104, and processing circuitry (not shown). An image or multiple images may be projected onto the display surface 102, such as by a microdisplay. Alternatively, some or all of the display surface 102 may be an active display (e.g., an organic light-emitting diode (OLED)) display able to produce an image in front of the user. The display also may be provided using retinal projection of various types of light, using a range of mechanisms, including (but not limited to) waveguides, scanning raster, color-separation and other mechanisms.

The camera array 104 may include one or more cameras able to capture visible light, infrared, or the like, and may be used as 2D or 3D cameras (e.g., depth camera). The camera array 104 may be configured to detect a gesture made by the user (wearer).

An inward-facing camera array (not shown) may be used to track eye movement and determine directionality of eye gaze. Gaze detection may be performed using a non-contact, optical method to determine eye motion. Infrared light may be reflected from the user's eye and sensed by an inward-facing video camera or some other optical sensor. The information is then analyzed to extract eye rotation based on the changes in the reflections from the user's retina. Another implementation may use video to track eye movement by analyzing a corneal reflection (e.g., the first Purkinje image) and the center of the pupil. Use of multiple Purkinje reflections may be used as a more sensitive eye tracking method. Other tracking methods may also be used, such as tracking retinal blood vessels, infrared tracking, or near-infrared tracking techniques. A user may calibrate the user's eye positions before actual use.

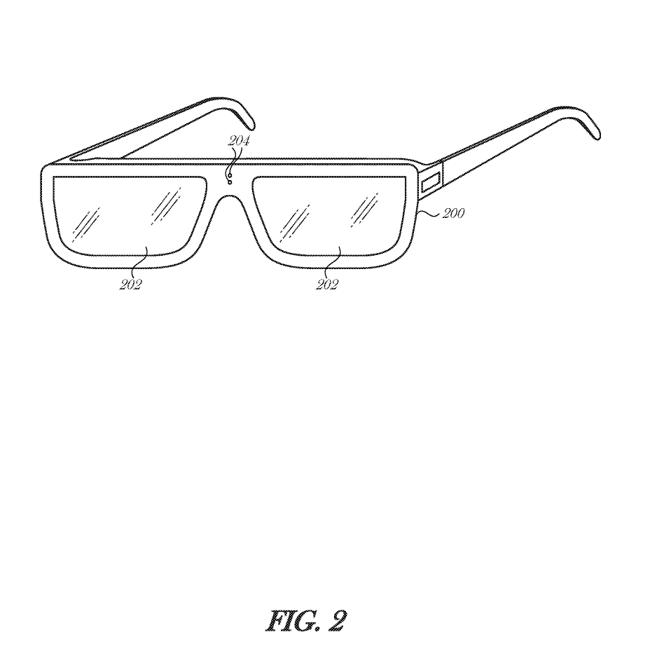

FIG. 2 is another HMD 200, according to embodiment. The HMD 200 in FIG. 2 is in the form of eyeglasses. Similar to the HMD 100 of FIG. 1, HMD 200 includes two display surfaces 202 and a camera array 204. Processing circuitry and inward facing cameras (not shown) may perform the functions described above.

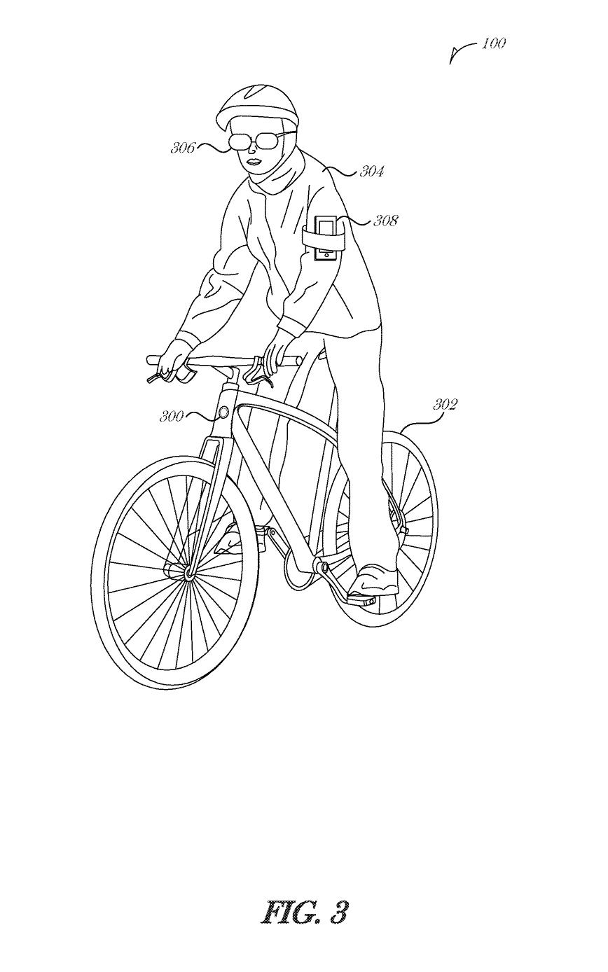

FIG. 3 is another example configuration, according to an embodiment. In FIG. 3, a camera system 300 is mounted on a bicycle 302. A user 304 (e.g., bicyclist) may use an HMD 306 to view an augmented reality around her. The camera system 300 detects preceding traffic (e.g., other bicyclists, pedestrians, skateboarders, etc.) and the HMD 306 presents notifications in augmented reality to the user 304. The camera system 300 and HMD 306 may be connected through a wireless or wired connection. Example wireless connections include Bluetooth, Wi-Fi, or the like. Although the HMD 306 illustrated in FIG. 3 is in the form of glasses, it is understood that the HMD 306 may take on various other forms, such as being incorporated into a bike helmet, googles, or the like, as illustrated in FIGS. 1-2.

The user 304 may also use a mobile device 308 to perform sensor fusion, computation, or display processing for the HMD 306. For example, the mobile device 308 may receive sensor data from the camera system 300, process the data to identify a dangerous situation such as a bicyclist in front of the user 304 is slowing down or moving erratically, and cause the HMD 306 to display AR content to notify the user 304 of the dangerous situation. The mobile device 308 in FIG. 3 is a smartphone held in place on the user's arm. The mobile device 308 may provide the user 304 the ability to listen to music, receive phone calls, record voice notes, and other functions. The mobile device 308 may be used as a graphics processor and push video or image data to the HMD 306 for presentation to the user 304. Alternatively, the mobile device 308 may be used for sensor processing and provide control signals to the HMD 306, which then creates the proper image data to present to the user 304.

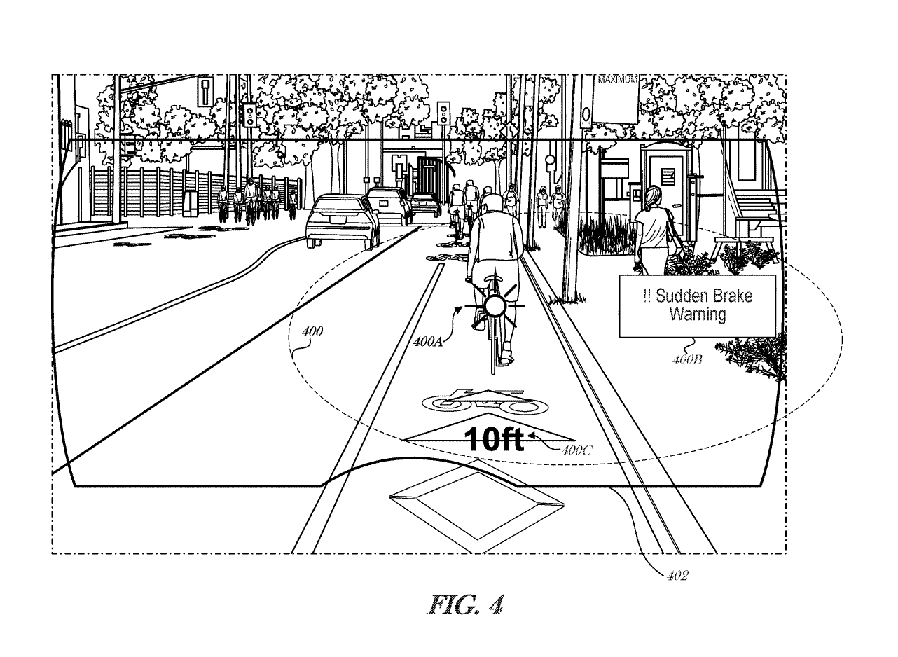

FIG. 4 is an example augmented reality user interface, according to an embodiment. In FIG. 4, the user is presented AR content 400 within the HMD's field of view 402. The AR content 400 may include several elements including a simulated brake light 400A, a textual warning 400B, and indications of distance from the preceding object 400C. More or fewer elements may be provided in the AR content. Additional forms of notification may also be combined with the AR content 400, such as audible alerts, voice alerts, haptic feedback, and the like.

AR content 400A-C may be displayed individually or collectively, based on context. For example, based on the urgency of the dangerous situation, several AR content elements 400A-C may be presented simultaneously. For instance, the distance AR element 400C may be shown if the user is less than 10 feet from a moving object in front. Within 10 feet, sudden deceleration may also cause the AR element brake light 400A to be shown along with warning 400B.

In the example illustrated in FIG. 4, if a bicycle rider in front of the wearer is slowing down at a high rate (e.g., decelerating rapidly), the AR display may superimpose a brake light at the tail of the bike in front of the wearer/rider. The interaction is nuanced and contextual, provoking minimal mental effort for large gains in safety.

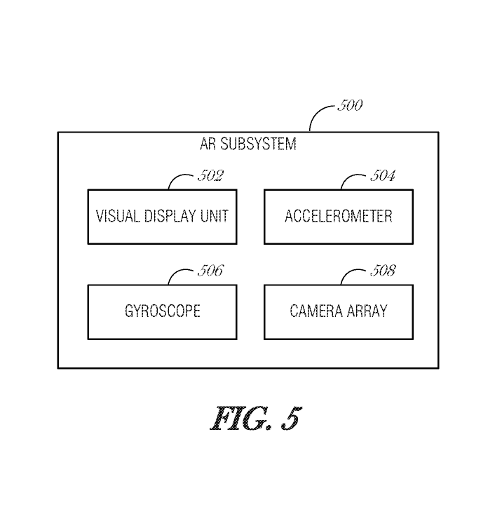

FIG. 5 is a schematic drawing illustrating an AR subsystem 500 in the form of a head-mounted display, according to an embodiment. The AR subsystem 500 includes a visual display unit 502, an accelerometer 504, a gyroscope 506, and a world-facing camera array 508.

The visual display unit 502 is operable to present a displayed image to the wearer (e.g., user) of the AR subsystem 500. The visual display unit 502 may operate in any manner including projecting images onto a translucent surface between the user's eye(s) and the outer world, the translucent surface may implement mirrors, lenses, prisms, waveguides, color filters, or other optical apparatus to generate an image. The visual display unit 502 may operate by projecting images directly onto the user's retinas. In general, the visual display unit 502 operates to provide an augmented reality (AR) experience where the user is able to view most of the real world around her with the computer generated image (CGI) (e.g., AR content) being a relatively small portion of the user's field of view. The mixture of the virtual images and the real-world experience provides an immersive, mobile, and flexible experience.

Alternatively, in some form factors, the visual display unit 502 may provide an AR experience on a handheld or mobile device's display screen. For example, the visual display unit 502 may be a light-emitting diode (LED) screen, organic LED screen, liquid crystal display (LCD) screen, or the like, incorporated into a tablet computer, smartphone, or other mobile device. When a user holds the mobile device in a certain fashion, a world-facing camera array on the backside of the mobile device may operate to capture the environment, which may be displayed on the screen. Additional information (e.g., AR content) may be presented next to representations of real-world objects. The AR content may be overlaid on top of the real-world object, obscuring the real-world object in the presentation on the visual display unit 502. Alternatively, the presentation of the AR content may be on a sidebar, in a margin, in a popup window, in a separate screen, as scrolling text (e.g., in a subtitle format), or the like.

The AR subsystem 500 includes an inertial tracking system that employs a sensitive inertial measurement unit (IMU). The IMU may include the accelerometer 504 and the gyroscope 506, and optionally includes a magnetometer. The IMU is an electronic device that measures a specific force, angular rate, and sometimes magnetic field around the AR subsystem 500. The IMU may calculate six degrees of freedom allowing the AR subsystem 500 to align AR content to the physical world or to generally determine the position or movement of the user's head.

The world-facing camera array 508 may include one or more infrared or visible light cameras, able to focus at long-range or short-range with narrow or large fields of view. The world-facing camera array 508 may be used to capture user gestures for gesture control input, environmental landmarks, people's faces, or other information to be used by the AR subsystem 500. The world-facing camera array 508 may be optionally affixed to a transportation device, such as on a frame of a bicycle, scooter, automobile, or the like.

In operation, while the user is wearing the AR subsystem 500, the user may be traveling in traffic. Sensors installed on the AR subsystem 500, or on a vehicle being operated by the user, may be used to detect when preceding traffic accelerates or decelerates in front of the user. For example, the camera array 508 may be used to capture images of preceding traffic. Based on image analysis, the AR subsystem 500 may detect quick deceleration of a preceding object. The AR subsystem 500 may then present one or more alerts in the AR content displayed in the visual display unit 502. Other types of sensors may be installed on the AR subsystem 500 to detect distances to objects in front of the user and determine whether the objects are slowing down or accelerating away from the user.

Alternatively, the sensors may be built into the body (e.g., frame, molding, fender, bumper, etc.) of a vehicle the user is operating. For example, a distance sensor may be affixed to, or incorporate in, a bike frame. The distance sensor may be one or more types of sensors including, but not limited to a depth camera, radar, sonar, or LIDAR. Sensor information may be passed to the AR subsystem 500 directly. Alternatively, the sensor information may be passed to an auxiliary computing device, such as a smartphone, cellular phone, laptop, tablet, or the like, such as the smartphone 308 illustrated in FIG. 3. The auxiliary computing device may process the sensor information and provide signals to the AR subsystem 500 to display AR content accordingly.

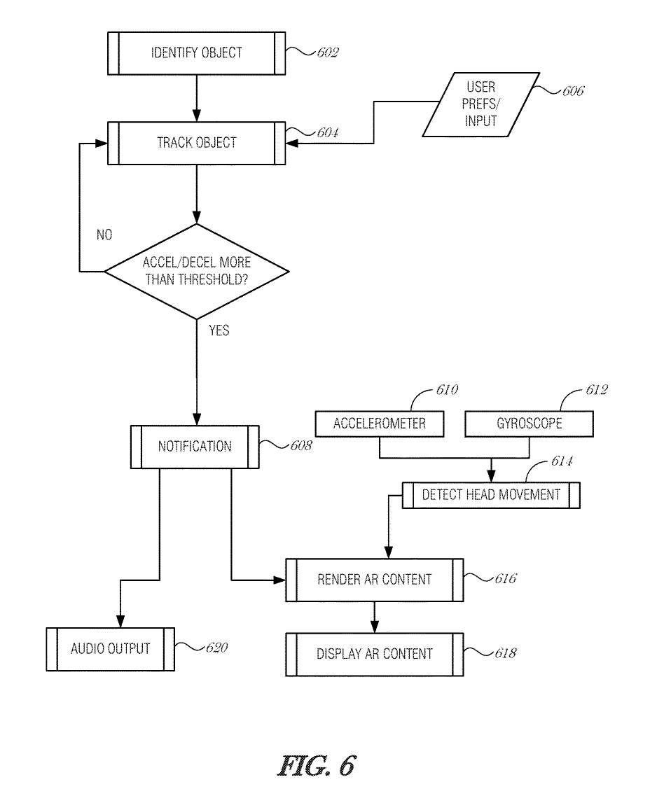

FIG. 6 is a flowchart illustrating control and data flow, according to an embodiment. An object (e.g., a person on a bicycle) is identified in the field of view of the user (operation 602). The object may be identified using various image processing techniques, such as object recognition classifiers, neural networks, or the like. Object recognition is a field of study within the general field of computer vision. Object recognition is the process of finding and identifying objects in images or videos. Typical approaches for object recognition use a trainable classifier. The classifier uses different input methods, such as feature extraction, gradient-based and derivative-based matching, and image segmentation and blob analysis. Various methods may be used including, but not limited to edge matching, divide-and-conquer searching, greyscale matching, gradient matching, histogram analysis, and machine learning (e.g., genetic algorithms) An image processor may implement relatively simple classifiers to identify potential objects of interest in a low-resolution image. The image processor may also implement relatively complex classifiers to more specifically identify an object of interest in a high-resolution image.

Based on the object recognized, tracking may be initiated (operation 604). Object tracking may be performed using a variety of technologies, such as with radar, LIDAR, depth cameras, sonar, etc. The object tracking may be used to determine whether the distance between the user and the object is increasing (e.g., the object is accelerating) or decreasing (e.g., the object is decelerating). A positioning system (e.g., GPS) on the vehicle may be used to determine the traveling speed of the user. Using the distance to the object, the rate of change of the distance, the traveling speed of the user, and other factors, it is determined whether the object is moving toward or away from the user at more than a threshold rate. The threshold rate may be configurable by stored user preferences or user input to adjust the threshold rate (data 606). The threshold rates may be individually assigned for accelerating objects and decelerating objects.

When the object preceding the user is accelerating or decelerating more than a threshold rate, then one or more notifications may be presented. The notifications may be presented as AR content in an HMD, for example, or alternatively or in addition to, as various forms of audio output to the user. The notifications may be different for an object that is accelerating away from or decelerating toward the user.

In an aspect, when the object is accelerating away from the user at more than a threshold rate, then the object may be highlighted in color. For example, if a bicycle is extending the gap between the user and the preceding bicycle, then the bicycle may be highlighted in green to notify the user that the preceding bicycle is moving away. This may be useful to keep traffic flowing in a relatively constant state and avoid unnecessary traffic waves, which may be caused in part when those following are slow to accelerate after previously slowing down.

In another aspect, arrows may be presented on the ground behind the object and in front of the user as AR content. The arrows may vary in number, intensity, color, texture, animation, or the like to provide additional feedback to the user of how the preceding object is acting. Thus, in such an aspect, when the preceding traveler is moving away from the user (e.g., accelerating with respect to the user), then the arrows may animate in a forward motion and be colored green. When the object is decelerating with respect to the user, the arrows may turn red and pulse to indicate a dangerous situation.

In another aspect, a textual notification may be presented to the user as AR content. The textual notification may indicate the behavior of the preceding object.

In another aspect, audio is used to enhance the notification. The audio may be a chime, bell, warning sound, voice, or other musical or tonal notification consistent with the type of notification (e.g., warning buzzer when there is quick deceleration and a soft chime when the preceding object is accelerating).

Each of these types of notifications may be used in combination with one another or preferentially configured by the user, for example.

An accelerometer 610 and a gyroscope 612 are used to detect head movement (operation 614). AR content is rendered (operation 616) and may be oriented based on the head movement detected at 614 to maintain a consistent visual cohesiveness between AR content and the real world. The AR content is presented to the user at operation 618. Audio output is optionally output to the user (operation 620).

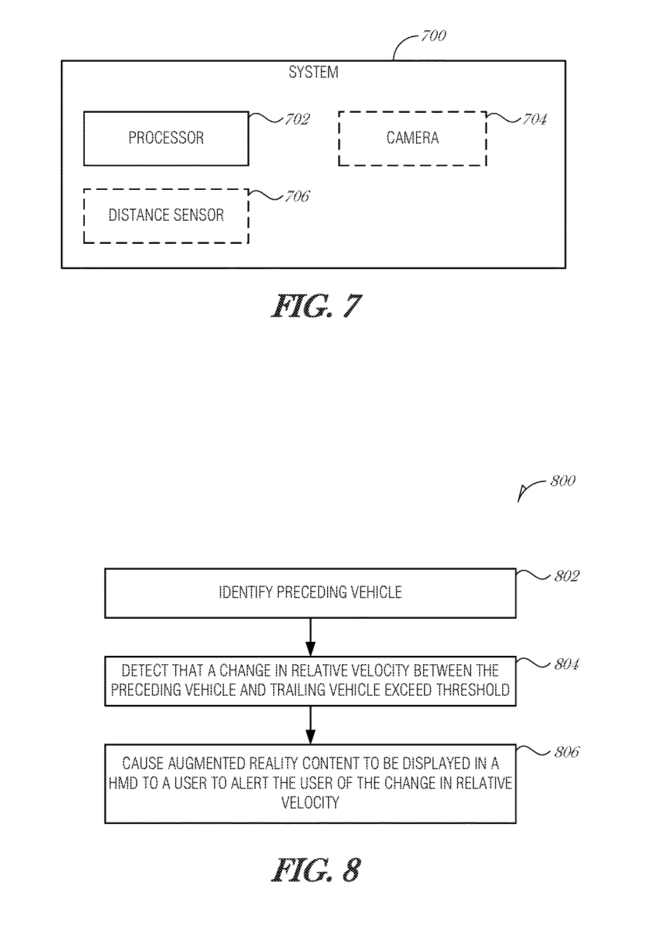

FIG. 7 is a block diagram illustrating a system 700 for traffic monitoring and providing alerts of preceding traffic, according to an embodiment. The system 700 may include a processor 702 and optionally a camera 704 and a distance sensor 706. The camera 704 may be an RGB camera, infrared, etc. The distance sensor 706 may be of various technologies, such as radar, LIDAR, sonar, depth camera, or the like.

The processor 702 may installed on a trailing vehicle operated by a user, and be configured to receive image data from the camera 704 and identify a preceding vehicle in front of the trailing vehicle. In an embodiment, to identify the preceding vehicle, the processor 702 is to access an image of a scene in front of the trailing vehicle and use object recognition analysis of the image to identify the preceding vehicle.

The processor 702 may be further configured to receive data from a distance sensor 706 to detect a change in relative velocity between the preceding vehicle and the trailing vehicle that exceeds a threshold. In an embodiment, to detect the change in relative velocity, the processor 702 is to track the relative velocity between the preceding vehicle and the trailing vehicle using at least one of a sonar system, a radar system, a LIDAR system, or a depth camera system. Such systems may be incorporated into or represented by the distance sensor 706.

The processor 702 may also be configured to cause an augmented reality content to be displayed in a head-mounted display worn by the user, to alert the user of the change in relative velocity.

In an embodiment, to cause the augmented reality content to be displayed, the processor 702 is to generate a video signal and transmit the video signal to the head-mounted display worn by the user.

In an embodiment, the change in relative velocity between the preceding vehicle and the trailing vehicle indicates that the preceding vehicle is decelerating with respect to the trailing vehicle, and wherein the augmented reality content comprises a visual alert. In a further embodiment, the visual alert comprises an overlay of a brake light on a rear portion of the preceding vehicle. In a further embodiment, the rear portion of the preceding vehicle comprises a seat of a bicycle. In a related embodiment, the rear portion of the preceding vehicle comprises a rear wheel of the preceding vehicle.

In a further embodiment, the brake light changes color as a function of a distance between the preceding vehicle and the trailing vehicle. Other aspects of the brake light's presentation may be altered based on the distance between the preceding vehicle and the trailing vehicle, such as a number of lights, intensity, color, texture, animation, or the like to provide additional feedback to the user of how the preceding object is acting. Thus, in an embodiment, the brake light changes intensity as a function of a distance between the preceding vehicle and the trailing vehicle.

In a related embodiment, the brake light changes a blinking rate as a function of a distance between the preceding vehicle and the trailing vehicle. In a related embodiment, the brake light changes size as a function of a distance between the preceding vehicle and the trailing vehicle.

In an embodiment, the visual alert comprises a textual alert.

In an embodiment, the visual alert comprises a highlighted portion overlaying at least a portion of the preceding vehicle. In a further embodiment, the highlighted portion changes color as a function of a distance between the preceding vehicle and the trailing vehicle.

In an embodiment, the visual alert comprises a numerical representation of a distance between the preceding vehicle and the trailing vehicle. In a further embodiment, the numerical representation changes color as a function of the distance between the preceding vehicle and the trailing vehicle.

In an embodiment, the change in relative velocity between the preceding vehicle and the trailing vehicle indicates that the preceding vehicle is accelerating with respect to the trailing vehicle, and wherein the augmented reality content comprises a visual alert. In a further embodiment, the visual alert comprises a green overlay on at least a portion of the preceding vehicle.

In an embodiment, the processor 702 is to cause an audible alert to be presented to the user on the trailing vehicle based on the change in relative velocity. In a further embodiment, the audible alert comprises a verbal notification. In a related embodiment, the audible alert comprises a tone.

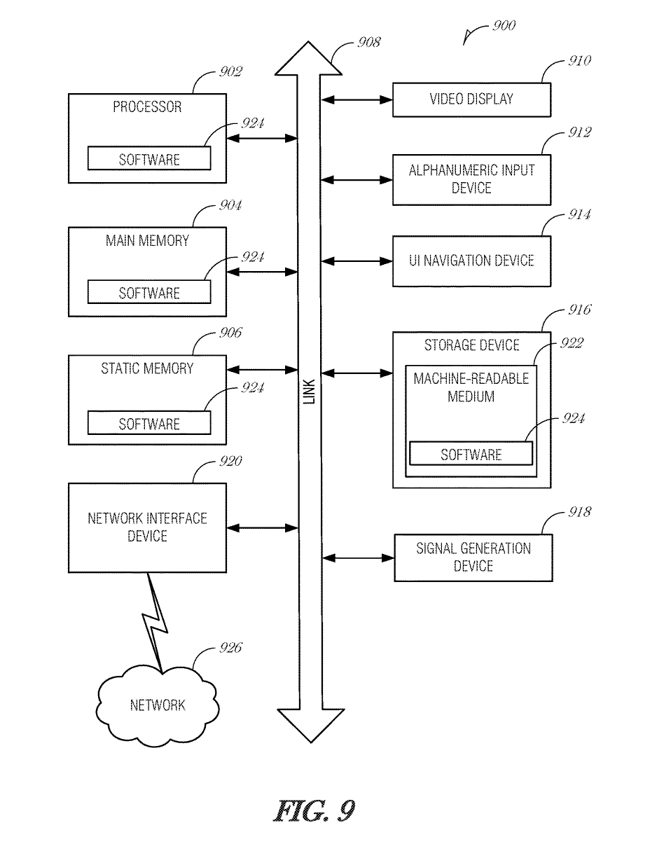

FIG. 8 is a flowchart illustrating a method 800 of monitoring and providing alerts regarding preceding traffic, according to an embodiment. At block 802, a preceding vehicle in front of a trailing vehicle is identified by a computerized traffic monitoring system operated by a user on the trailing vehicle. In an embodiment, identifying the preceding vehicle comprises accessing an image of a scene in front of the trailing vehicle and using object recognition analysis of the image to identify the preceding vehicle.

At block 804, a change in relative velocity between the preceding vehicle and the trailing vehicle that exceeds a threshold is detected. In an embodiment, detecting the change in relative velocity comprises tracking the relative velocity between the preceding vehicle and the trailing vehicle using at least one of: a sonar system, a radar system, a LIDAR system, or a depth camera system.

At block 806, an augmented reality content is caused to be displayed in a head-mounted display worn by the user, to alert the user of the change in relative velocity. In an embodiment, causing the augmented reality content to be displayed comprises generating a video signal and transmitting the video signal to the head-mounted display worn by the user. Such may be the case when the augmented reality content is rendered in an auxiliary device (e.g., a smartphone) and the video signals are provided to an output device (e.g., an HMD). In other embodiments, the HMD may process the video onboard.

In an embodiment, the change in relative velocity between the preceding vehicle and the trailing vehicle indicates that the preceding vehicle is decelerating with respect to the trailing vehicle, and in such a case, the augmented reality content comprises a visual alert. The visual alert may be one or more portions of augmented content displayed to the user in the HMD.

In an embodiment, the visual alert comprises an overlay of a brake light on a rear portion of the preceding vehicle. In a further embodiment, the rear portion of the preceding vehicle comprises a seat of a bicycle. In a related embodiment, the rear portion of the preceding vehicle comprises a rear wheel of the preceding vehicle. In a related embodiment, the brake light changes color as a function of a distance between the preceding vehicle and the trailing vehicle. For example, as the two vehicles become closer together the color of the brake light may change from yellow to red, increase in brightness or intensity, etc. In another related embodiment, the brake light changes a blinking rate as a function of a distance between the preceding vehicle and the trailing vehicle. For example, the brake light may not blink when the vehicles are spaced far apart from each other and as they get closer, the rate of blinking may increase to attract the user's attention. In another related embodiment, the brake light changes size as a function of a distance between the preceding vehicle and the trailing vehicle. For example, the brake light may be enlarged as the vehicles become closer together.

In an embodiment, the visual alert comprises a textual alert. The textual alert may have various textual enhancements, such as flashing text, scrolling text, bold, highlighted text, or the like.

In an embodiment, the visual alert comprises a highlighted portion overlaying at least a portion of the preceding vehicle. For example, a circle, square, or other shape may be generally displayed to highlight one or more preceding vehicles. Vehicles that travel in a pack, such as a group of bicyclists, may all slow down at a fast rate, and the user may be alerted that the group is slowing down and creating a potential collision hazard.

In a further embodiment, the highlighted portion changes color as a function of a distance between the preceding vehicle and the trailing vehicle. As with the brake light augmented reality content, the highlighted portion may change from one color to another as the distance between vehicles shortens. The color progression may be from yellow to orange to red, in an example embodiment.

In an embodiment, the visual alert comprises a numerical representation of a distance between the preceding vehicle and the trailing vehicle. The number may be updated in near real time or periodically, such as every two seconds. The number may represent a measurement in any unit, such as feet, meters, yards, or the like. As with the augmented reality content brake light and highlighted areas, the numerical representation may also change color. Thus, in an embodiment, the numerical representation changes color as a function of the distance between the preceding vehicle and the trailing vehicle.

In an embodiment, the change in relative velocity between the preceding vehicle and the trailing vehicle indicates that the preceding vehicle is accelerating with respect to the trailing vehicle, and in such a case, the augmented reality content comprises a visual alert. In an embodiment, the visual alert comprises a green overlay on at least a portion of the preceding vehicle.

In an embodiment, the method 800 includes causing an audible alert to be presented to the user on the trailing vehicle based on the change in relative velocity. In a further embodiment, the audible alert comprises a verbal notification. For example, a computer-generated voice or a pre-recorded voice may be used to notify the user of approaching or departing traffic in front of the user. In a related embodiment, the audible alert comprises a tone. For example, a warning buzzer may be used to notify the user of imminent collision or other dangerous situations.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 9 is a block diagram illustrating a machine in the example form of a computer system 900, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 900 includes at least one processor 902 (e.g., a central processing unit (CPU), a graphics processing unit (GPU) or both, processor cores, compute nodes, etc.), a main memory 904 and a static memory 906, which communicate with each other via a link 908 (e.g., bus). The computer system 900 may further include a video display unit 910, an alphanumeric input device 912 (e.g., a keyboard), and a user interface (UI) navigation device 914 (e.g., a mouse). In one embodiment, the video display unit 910, input device 912 and UI navigation device 914 are incorporated into a touch screen display. The computer system 900 may additionally include a storage device 916 (e.g., a drive unit), a signal generation device 918 (e.g., a speaker), a network interface device 920, and one or more sensors (not shown), such as a global positioning system (GPS) sensor, compass, accelerometer, gyrometer, magnetometer, or other sensor.

The storage device 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904, static memory 906, and/or within the processor 902 during execution thereof by the computer system 900, with the main memory 904, static memory 906, and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions 924. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 924 may further be transmitted or received over a communications network 926 using a transmission medium via the network interface device 920 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for providing alerts of preceding traffic (such as a device, apparatus, or machine) comprising: a processor installed on a trailing vehicle operated by a user, the processor to: receive image data from a camera and identify a preceding vehicle in front of the trailing vehicle; receive data from a distance sensor to detect a change in relative velocity between the preceding vehicle and the trailing vehicle that exceeds a threshold; and cause an augmented reality content to be displayed in a head-mounted display worn by the user, the augmented reality content to alert the user of the change in relative velocity.

In Example 2, the subject matter of Example 1 may include, wherein to identify the preceding vehicle, the processor is to: access an image of a scene in front of the trailing vehicle; and use object recognition analysis of the image to identify the preceding vehicle.

In Example 3, the subject matter of any one of Examples 1 to 2 may include, wherein to detect the change in relative velocity, the processor is to track the relative velocity between the preceding vehicle and the trailing vehicle using at least one of: a sonar system, a radar system, a LIDAR system, or a depth camera system.

In Example 4, the subject matter of any one of Examples 1 to 3 may include, wherein to cause the augmented reality content to be displayed, the processor is to generate a video signal and transmit the video signal to the head-mounted display worn by the user.

In Example 5, the subject matter of any one of Examples 1 to 4 may include, wherein the change in relative velocity between the preceding vehicle and the trailing vehicle indicates that the preceding vehicle is decelerating with respect to the trailing vehicle, and wherein the augmented reality content comprises a visual alert.

In Example 6, the subject matter of any one of Examples 1 to 5 may include, wherein the visual alert comprises an overlay of a brake light on a rear portion of the preceding vehicle.

In Example 7, the subject matter of any one of Examples 1 to 6 may include, wherein the rear portion of the preceding vehicle comprises a seat of a bicycle.

In Example 8, the subject matter of any one of Examples 1 to 7 may include, wherein the rear portion of the preceding vehicle comprises a rear wheel of the preceding vehicle.

In Example 9, the subject matter of any one of Examples 1 to 8 may include, wherein the brake light changes color as a function of a distance between the preceding vehicle and the trailing vehicle.

In Example 10, the subject matter of any one of Examples 1 to 9 may include, wherein the brake light changes intensity as a function of a distance between the preceding vehicle and the trailing vehicle.

In Example 11, the subject matter of any one of Examples 1 to 10 may include, wherein the brake light changes a blinking rate as a function of a distance between the preceding vehicle and the trailing vehicle.

In Example 12, the subject matter of any one of Examples 1 to 11 may include, wherein the brake light changes size as a function of a distance between the preceding vehicle and the trailing vehicle.

In Example 13, the subject matter of any one of Examples 1 to 12 may include, wherein the visual alert comprises a textual alert.

In Example 14, the subject matter of any one of Examples 1 to 13 may include, wherein the visual alert comprises a highlighted portion overlaying at least a portion of the preceding vehicle.

In Example 15, the subject matter of any one of Examples 1 to 14 may include, wherein the highlighted portion changes color as a function of a distance between the preceding vehicle and the trailing vehicle.

In Example 16, the subject matter of any one of Examples 1 to 15 may include, wherein the visual alert comprises a numerical representation of a distance between the preceding vehicle and the trailing vehicle.

In Example 17, the subject matter of any one of Examples 1 to 16 may include, wherein the numerical representation changes color as a function of the distance between the preceding vehicle and the trailing vehicle.

In Example 18, the subject matter of any one of Examples 1 to 17 may include, wherein the change in relative velocity between the preceding vehicle and the trailing vehicle indicates that the preceding vehicle is accelerating with respect to the trailing vehicle, and wherein the augmented reality content comprises a visual alert.

In Example 19, the subject matter of any one of Examples 1 to 18 may include, wherein the visual alert comprises a green overlay on at least a portion of the preceding vehicle.

In Example 20, the subject matter of any one of Examples 1 to 19 may include, wherein the processor is to cause an audible alert to be presented to the user on the trailing vehicle based on the change in relative velocity.

In Example 21, the subject matter of any one of Examples 1 to 20 may include, wherein the audible alert comprises a verbal notification.

In Example 22, the subject matter of any one of Examples 1 to 21 may include, wherein the audible alert comprises a tone.

Example 23 includes subject matter for providing alerts of preceding traffic (such as a method, means for performing acts, machine readable medium including instructions that when performed by a machine cause the machine to performs acts, or an apparatus to perform) comprising: identifying, by a computerized traffic monitoring system operated by a user on a trailing vehicle, a preceding vehicle in front of the trailing vehicle; detecting a change in relative velocity between the preceding vehicle and the trailing vehicle that exceeds a threshold; and causing an augmented reality content to be displayed in a head-mounted display worn by the user, to alert the user of the change in relative velocity.

In Example 24, the subject matter of Example 23 may include, wherein identifying the preceding vehicle comprises: accessing an image of a scene in front of the trailing vehicle; and using object recognition analysis of the image to identify the preceding vehicle.

In Example 25, the subject matter of any one of Examples 23 to 24 may include, wherein detecting the change in relative velocity comprises tracking the relative velocity between the preceding vehicle and the trailing vehicle using at least one of: a sonar system, a radar system, a LIDAR system, or a depth camera system.

In Example 26, the subject matter of any one of Examples 23 to 25 may include, wherein causing the augmented reality content to be displayed comprises generating a video signal and transmitting the video signal to the head-mounted display worn by the user.

In Example 27, the subject matter of any one of Examples 23 to 26 may include, wherein the change in relative velocity between the preceding vehicle and the trailing vehicle indicates that the preceding vehicle is decelerating with respect to the trailing vehicle, and wherein the augmented reality content comprises a visual alert.

In Example 28, the subject matter of any one of Examples 23 to 27 may include, wherein the visual alert comprises an overlay of a brake light on a rear portion of the preceding vehicle.

In Example 29, the subject matter of any one of Examples 23 to 28 may include, wherein the rear portion of the preceding vehicle comprises a seat of a bicycle.

In Example 30, the subject matter of any one of Examples 23 to 29 may include, wherein the rear portion of the preceding vehicle comprises a rear wheel of the preceding vehicle.

In Example 31, the subject matter of any one of Examples 23 to 30 may include, wherein the brake light changes color as a function of a distance between the preceding vehicle and the trailing vehicle.

In Example 32, the subject matter of any one of Examples 23 to 31 may include, wherein the brake light changes intensity as a function of a distance between the preceding vehicle and the trailing vehicle.

In Example 33, the subject matter of any one of Examples 23 to 32 may include, wherein the brake light changes a blinking rate as a function of a distance between the preceding vehicle and the trailing vehicle.

In Example 34, the subject matter of any one of Examples 23 to 33 may include, wherein the brake light changes size as a function of a distance between the preceding vehicle and the trailing vehicle.

In Example 35, the subject matter of any one of Examples 23 to 34 may include, wherein the visual alert comprises a textual alert.

In Example 36, the subject matter of any one of Examples 23 to 35 may include, wherein the visual alert comprises a highlighted portion overlaying at least a portion of the preceding vehicle.

In Example 37, the subject matter of any one of Examples 23 to 36 may include, wherein the highlighted portion changes color as a function of a distance between the preceding vehicle and the trailing vehicle.

In Example 38, the subject matter of any one of Examples 23 to 37 may include, wherein the visual alert comprises a numerical representation of a distance between the preceding vehicle and the trailing vehicle.

In Example 39, the subject matter of any one of Examples 23 to 38 may include, wherein the numerical representation changes color as a function of the distance between the preceding vehicle and the trailing vehicle.

In Example 40, the subject matter of any one of Examples 23 to 39 may include, wherein the change in relative velocity between the preceding vehicle and the trailing vehicle indicates that the preceding vehicle is accelerating with respect to the trailing vehicle, and wherein the augmented reality content comprises a visual alert.

In Example 41, the subject matter of any one of Examples 23 to 40 may include, wherein the visual alert comprises a green overlay on at least a portion of the preceding vehicle.

In Example 42, the subject matter of any one of Examples 23 to 41 may include, causing an audible alert to be presented to the user on the trailing vehicle based on the change in relative velocity.

In Example 43, the subject matter of any one of Examples 23 to 42 may include, wherein the audible alert comprises a verbal notification.

In Example 44, the subject matter of any one of Examples 23 to 43 may include, wherein the audible alert comprises a tone.

Example 45 includes at least one machine-readable medium including instructions, which when executed by a machine, cause the machine to perform operations of any of the Examples 23-44.

Example 46 includes an apparatus comprising means for performing any of the Examples 23-44.

Example 47 includes subject matter for providing alerts of preceding traffic (such as a device, apparatus, or machine) comprising: means for identifying, by a computerized traffic monitoring system operated by a user on a trailing vehicle, a preceding vehicle in front of the trailing vehicle; means for detecting a change in relative velocity between the preceding vehicle and the trailing vehicle that exceeds a threshold; and means for causing an augmented reality content to be displayed in a head-mounted display worn by the user, to alert the user of the change in relative velocity.

In Example 48, the subject matter of Example 47 may include, wherein the means for identifying the preceding vehicle comprise: means for accessing an image of a scene in front of the trailing vehicle; and means for using object recognition analysis of the image to identify the preceding vehicle.

In Example 49, the subject matter of any one of Examples 47 to 48 may include, wherein the means for detecting the change in relative velocity comprise means for tracking the relative velocity between the preceding vehicle and the trailing vehicle using at least one of: a sonar system, a radar system, a LIDAR system, or a depth camera system.

In Example 50, the subject matter of any one of Examples 47 to 49 may include, wherein the means for causing the augmented reality content to be displayed comprise means for generating a video signal and transmitting the video signal to the head-mounted display worn by the user.

In Example 51, the subject matter of any one of Examples 47 to 50 may include, wherein the change in relative velocity between the preceding vehicle and the trailing vehicle indicates that the preceding vehicle is decelerating with respect to the trailing vehicle, and wherein the augmented reality content comprises a visual alert.

In Example 52, the subject matter of any one of Examples 47 to 51 may include, wherein the visual alert comprises an overlay of a brake light on a rear portion of the preceding vehicle.

In Example 53, the subject matter of any one of Examples 47 to 52 may include, wherein the rear portion of the preceding vehicle comprises a seat of a bicycle.

In Example 54, the subject matter of any one of Examples 47 to 53 may include, wherein the rear portion of the preceding vehicle comprises a rear wheel of the preceding vehicle.

In Example 55, the subject matter of any one of Examples 47 to 54 may include, wherein the brake light changes color as a function of a distance between the preceding vehicle and the trailing vehicle.

In Example 56, the subject matter of any one of Examples 47 to 55 may include, wherein the brake light changes intensity as a function of a distance between the preceding vehicle and the trailing vehicle.

In Example 57, the subject matter of any one of Examples 47 to 56 may include, wherein the brake light changes a blinking rate as a function of a distance between the preceding vehicle and the trailing vehicle.

In Example 58, the subject matter of any one of Examples 47 to 57 may include, wherein the brake light changes size as a function of a distance between the preceding vehicle and the trailing vehicle.

In Example 59, the subject matter of any one of Examples 47 to 58 may include, wherein the visual alert comprises a textual alert.

In Example 60, the subject matter of any one of Examples 47 to 59 may include, wherein the visual alert comprises a highlighted portion overlaying at least a portion of the preceding vehicle.

In Example 61, the subject matter of any one of Examples 47 to 60 may include, wherein the highlighted portion changes color as a function of a distance between the preceding vehicle and the trailing vehicle.

In Example 62, the subject matter of any one of Examples 47 to 61 may include, wherein the visual alert comprises a numerical representation of a distance between the preceding vehicle and the trailing vehicle.

In Example 63, the subject matter of any one of Examples 47 to 62 may include, wherein the numerical representation changes color as a function of the distance between the preceding vehicle and the trailing vehicle.

In Example 64, the subject matter of any one of Examples 47 to 63 may include, wherein the change in relative velocity between the preceding vehicle and the trailing vehicle indicates that the preceding vehicle is accelerating with respect to the trailing vehicle, and wherein the augmented reality content comprises a visual alert.

In Example 65, the subject matter of any one of Examples 47 to 64 may include, wherein the visual alert comprises a green overlay on at least a portion of the preceding vehicle.

In Example 66, the subject matter of any one of Examples 47 to 65 may include, means for causing an audible alert to be presented to the user on the trailing vehicle based on the change in relative velocity.

In Example 67, the subject matter of any one of Examples 47 to 66 may include, wherein the audible alert comprises a verbal notification.

In Example 68, the subject matter of any one of Examples 47 to 67 may include, wherein the audible alert comprises a tone.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for providing alerts of preceding traffic, the system comprising:
a processor installed on a trailing vehicle operated by a user, the processor to:
receive image data from a camera and identify a preceding vehicle in front of the trailing vehicle;
receive data from a distance sensor to detect a change in relative velocity between the preceding vehicle and the trailing vehicle that exceeds a threshold; and
cause an augmented reality content to be displayed in a head-mounted display worn by the user, the augmented reality content to alert the user of the change in relative velocity,
wherein the change in relative velocity between the preceding vehicle and the trailing vehicle indicates that the preceding vehicle is accelerating with respect to the trailing vehicle, and wherein the augmented reality content comprises a green overlay on at least a portion of the preceding vehicle.

2. The system of claim 1, wherein to identify the preceding vehicle, the processor is to:
access an image of a scene in front of the trailing vehicle; and
use object recognition analysis of the image to identify the preceding vehicle.

3. The system of claim 1, wherein to cause the augmented reality content to be displayed, the processor is to generate a video signal and transmit the video signal to the head-mounted display worn by the user.

4. The system of claim 1, wherein the change in relative velocity between the preceding vehicle and the trailing vehicle indicates that the preceding vehicle is decelerating with respect to the trailing vehicle, and wherein the augmented reality content comprises a visual alert.

5. The system of claim 4, wherein the visual alert comprises an overlay of a brake light on a rear portion of the preceding vehicle.

6. The system of claim 5, wherein the rear portion of the preceding vehicle comprises a seat of a bicycle.

7. The system of claim 5, wherein the brake light changes color as a function of a distance between the preceding vehicle and the trailing vehicle.

8. The system of claim 5, wherein the brake light changes a blinking rate as a function of a distance between the preceding vehicle and the trailing vehicle.

9. The system of claim 5, wherein the brake light changes size as a function of a distance between the preceding vehicle and the trailing vehicle.

10. The system of claim 4, wherein the visual alert comprises a textual alert.

11. The system of claim 4, wherein the visual alert comprises a highlighted portion overlaying at least a portion of the preceding vehicle, and wherein the highlighted portion changes color as a function of a distance between the preceding vehicle and the trailing vehicle.

12. A method of providing alerts of preceding traffic, the method comprising:
identifying, by a computerized traffic monitoring system operated by a user on a trailing vehicle, a preceding vehicle in front of the trailing vehicle;
detecting a change in relative velocity between the preceding vehicle and the trailing vehicle that exceeds a threshold; and
causing an augmented reality content to be displayed in a head-mounted display worn by the user, to alert the user of the change in relative velocity,
wherein the change in relative velocity between the preceding vehicle and the trailing vehicle indicates that the preceding vehicle is accelerating with respect to the trailing vehicle, and wherein the augmented reality content comprises a green overlay on at least a portion of the preceding vehicle.

13. The method of claim 12, wherein identifying the preceding vehicle comprises:
accessing an image of a scene in front of the trailing vehicle; and
using object recognition analysis of the image to identify the preceding vehicle.

14. The method of claim 12, wherein causing the augmented reality content to be displayed comprises generating a video signal and transmitting the video signal to the head-mounted display worn by the user.

15. The method of claim 12, wherein the change in relative velocity between the preceding vehicle and the trailing vehicle indicates that the preceding vehicle is decelerating with respect to the trailing vehicle, and wherein the augmented reality content comprises a visual alert.

16. The method of claim 15, wherein the visual alert comprises a textual alert.

17. The method of claim 15, wherein the visual alert comprises a highlighted portion overlaying at least a portion of the preceding vehicle.

18. The method of claim 17, wherein the highlighted portion changes color as a function of a distance between the preceding vehicle and the trailing vehicle.

19. The method of claim 15, wherein the visual alert comprises a numerical representation of a distance between the preceding vehicle and the trailing vehicle.

20. The method of claim 19, wherein the numerical representation changes color as a function of the distance between the preceding vehicle and the trailing vehicle.

21. At east one non-transitory machine-readable medium including instructions for providing alerts of preceding traffic, which when executed by a machine, cause the machine to:
identify, by a computerized traffic monitoring system operated by a user on a trailing vehicle, a preceding vehicle in front of the trailing vehicle;
detect a change in relative velocity between the preceding vehicle and the trailing that exceeds a threshold; and
cause an augmented reality content to be displayed in a head-mounted display worn by the user, to alert the user of the change in relative velocity,
wherein the change in relative velocity between the preceding vehicle and the trailing vehicle indicates that the preceding vehicle is accelerating with respect to the trailing vehicle, and wherein the augmented reality content comprises a green overlay on at least a portion of the preceding vehicle.

22. The at least one non-transitory machine-readable medium of claim 22, wherein the instructions to identify the preceding vehicle comprise instructions to:
access an image of a scene in front of the trailing vehicle; and
use object recognition analysis of the image to identify the preceding vehicle.

23. The at least one non-transitory machine-readable medium of claim 22, wherein the change in relative velocity between the preceding vehicle and the trailing vehicle indicates that the preceding vehicle is decelerating with respect to the trailing vehicle, and wherein the augmented reality content comprises a visual alert.

24. The at least one non-transitory machine-readable medium of claim 23, wherein the visual alert comprises an overlay of a brake light on a rear portion of the preceding vehicle.

25. The at least one non-transitory machine-readable medium of claim 24, wherein the rear portion of the preceding vehicle comprises a seat of a bicycle.
